(19) United States
(12) Patent Application Publication
(10) Pub. No.: US 2010/0093597 A1
(43) Pub. Date: Apr. 15, 2010

(54) ULTRA-CONCENTRATED SOLID DEGREASER COMPOSITION

(75) Inventor: Tami J. Tadrowski, Hillsborough, NC (US)

Correspondence Address: ECOLAB INC., MAIL STOP ESC-F7, 655 LONE OAK DRIVE, EAGAN, MN, 55121, US

(73) Assignee: ECOLAB INC., St. Paul, MN (US)

(21) Appl. No.: 12/418,910

(22) Filed: Apr. 6, 2009

Related U.S. Application Data
(60) Provisional application No. 61/042,909, filed on Apr. 7, 2008.

(51) Int. Cl. C11D 3/20

(52) U.S. Cl. 510/365

(57) ABSTRACT

A substantially nonaqueous solid concentrate composition is provided comprising an amine oxide surfactant, an alkali metal hydroxide, a secondary source of alkalinity, a chelating agent, a non-ionic surfactant, and a hardening agent wherein the concentrate composition is useful in preparing a stable, aqueous solution. The composition may optionally include any one or combination of an anionic surfactant, a corrosion inhibitor, dye, perfume, or preservative. The ultra-concentrated composition of the invention is uniquely suited for solid deliveries.

### RELATED APPLICATIONS

This application claims priority under 35 U.S.C. §119(e) to U.S. Provisional Application entitled “Ultraconcentrated Degreaser Composition for Use With Various Delivery Methods,” Ser. No. 61/042,909, filed on Apr. 7, 2008, which is incorporated herein by reference in its entirety for all purposes.

### FIELD OF THE INVENTION

The present invention is directed to compositions for the treatment of hard surfaces. The present invention relates to hard surface cleaning compositions, especially compositions that are ultra-concentrated, and dissolve and disperse satisfactorily in water and exhibit excellent stability and degreasing ability.

### BACKGROUND OF THE INVENTION

Liquid cleaning compositions comprising surfactants are known. Such compositions can be used, for example, as hard surface cleaners, in either dilutable form or in ready-to-use form which in addition to providing a useful detersive effect also provide a degreasing effect to a treated hard surface. Such compositions do not generally have any compatibility problems when being diluted with a large quantity of water.

For some purposes it is desirable to have liquid degreasing compositions that are anhydrous or substantially anhydrous. In some instances, when such compositions are anhydrous or substantially anhydrous, pre-measured doses can be prepared so that the user of the these compositions do not have to measure the appropriate amount of surfactant composition to use every time they wish to clean hard surfaces.

Thus, there is real and continuing need in the art for improved compositions that are useful in the cleaning of surfaces, particularly hard surfaces, and more particularly in providing degreasing abilities. There is a real and continuing need in the art for improved hard surface treatment compositions which provide a cleaning benefit and which overcomes one or more of the shortcomings of prior art hard surface cleaning compositions. Particularly, there is a need for further improved hard surface cleaning compositions which are provided in an ultra-concentrated format, dissolve quickly in water and are preferably not corrosive to soft metals such as aluminum. For hard surface cleaning compositions that contain caustic, there is a need for solid embodiments which can not splash into eyes or onto skin like caustic containing liquid hard surface cleaners.

The diluted use compositions are suitable for application to soiled surfaces for a sufficient period of time to loosen and remove any organic or greasy soil deposits from hard surfaces. The common target soil comprises combined organic/inorganic soils having a large organic component such as oils, fats, and other substantially aqueous insoluble organic media.

### BRIEF DESCRIPTION OF THE DRAWINGS

### Summary of the Invention

The present inventive concentrate composition is especially suitable for solid concentrates. The favorable dissolution and dispersion properties of the concentrate compositions according to the present invention are particularly useful in this context. The solid may be provided in any of the following solid forms including but not limited to powder, pellet, tablet, paste, extruded, cast or compacted solid. In any of the forms, the solid concentrate composition can be added to a large, premeasured quantity of water and dissolves forming a use solution. These forms can be packaged in tubs, bottles, pre-formed trays, water soluble film or water insoluble film. In any of the solid forms, the solid can be dispensed by having water sprayed on it or by having water flow over it, dissolving the solid and forming a use solution. The favorable dissolution and dispersion properties of the concentrate compositions according to the present invention are particularly useful in this context.

In one aspect, the invention involves using compositions of the invention as an additive in a fully formulated product that is used in aqueous solution for complex organic or greasy soil and inorganic soil removal. In such applications, the composition of the invention is combined in an aqueous solution and is designed for removing soil from a particular substrate. Such substrates include common hard surfaces. Such hard surfaces can exist in food preparation applications, restaurants, grocery stores, the household, offices, nursing homes, day cares, hospitals and other locations where food soils or other greasy soils can accumulate on hard surfaces. Such surfaces can be cleaned using a formulated hard surface cleaner that includes the composition of the invention as a degreasing or organic soil removing component.

Solid compositions of the invention may be either extruded or cast. As one skilled in the art will recognize, the composition will change according to the method used to obtain the solid.

A solid caustic-based concentrate for use in preparing a stable, aqueous cleaner/degreaser liquid composition in the form of a totally water soluble solution is provided comprising 1 to 10 wt % of an amine oxide surfactant, 0 to 5 wt % of an optional organic alkalinity source (preferably monoethanolamine and/or amino methyl propanol), 0 to 20 wt % of a powdered hydrotrope, 5 to 50 wt % of an alkalinity source which buffers use solution pH (preferably sodium carbonate or potassium carbonate, or a combination thereof), and 0.05 to 50 wt % of a powdered chelant, 0 to 10 wt % of sodium gluconate, 1 to 50 wt % of a caustic alkalinity component (preferably solid sodium hydroxide or solid potassium hydroxide), 0 to 50 wt % of an anionic surfactant (preferably granular sodium linear alkylbenzene sulfonate or sodium lauryl sulfate) and 0.05 to 20 wt % of a non-ionic surfactant (preferably a long chain alcohol alkoxylate). Additionally, any combination of corrosion inhibitors, preservative, fragrance, or dye is optionally added. In order to prepare a solid composition according to the invention a hardening agent such as urea, also known as carbamide, polyethylene glycols (PEG), polypropylene glycols (PPG), and starches may be included. Various inorganics that impart solidifying properties to the present composition can also be included. Such inorganic agents include calcium carbonate, magnesium sulfate, sodium sulfate, sodium bisulfate, alkali metal phosphates, sodium acetate and other known hydratable compounds.

### DETAILED DESCRIPTION OF THE INVENTION

The composition of the invention is unique in that it is suitable for solid delivery modes. Solid formats can include concentrated powders, pellets, tablets, pastes, or solid blocks. The pellets and tablets can be formed by compacting in a tableting machine. The solid blocks or pellets may be formed via extrusion techniques or via molding or casting.

For the following defined terms, these definitions shall be applied, unless a different definition is given in the claims or elsewhere in this specification.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure.

Weight percent, percent by weight, % by weight, and the like are synonyms that refer to the concentration of a substance as the weight of that substance divided by the weight of the composition and multiplied by 100.

The recitation of numerical ranges by endpoints includes all numbers subsumed within that range (e.g. 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. Thus, for example, reference to a composition containing “a compound” includes a mixture of two or more compounds. As used in this specification and the appended claims, the term “or” is generally employed in its sense including “and/or” unless the content clearly dictates otherwise.

The term “alkyl” refers to a straight or branched chain monovalent hydrocarbon radical having a specified number of carbon atoms. Alkyl groups may be unsubstituted or substituted with substituents that do not interfere with the specified function of the composition and may be substituted once or twice with the same or different group. Substituents may include alkoxy, hydroxy, mercapto, amino, alkyl substituted amino, nitro, carboxy, carbanoyl, carbanoyloxy, cyano, methylsulfonylamino, or halo, for example. Examples of “alkyl” include, but are not limited to, methyl, ethyl, n-propyl, isopropyl, n-butyl, s-butyl, t-butyl, n-pentyl, n-hexyl, 3-methylpentyl, and the like.

The term “alkoxy” refers to a straight or branched chain monovalent hydrocarbon radical having a specified number of carbon atoms and a carbon-oxygen-carbon bond, may be unsubstituted or substituted with substituents that do not interfere with the specified function of the composition and may be substituted once or twice with the same or different group. Substituents may include alkoxy, hydroxy, mercapto, amino, alkyl substituted amino, nitro, carboxy, carbanoyl, carbanoyloxy, cyano, methylsulfonylamino, or halo, for example. Examples include methoxy, ethoxy, propoxy, t-butoxy, and the like.

The terms EO, PO, or EO/PO as used herein refer to ethylene oxide and propylene oxide, respectively. EO/PO refers to ethylene oxide and propylene oxide block copolymers.

The term “surfactant” or “surface active agent” refers to an organic chemical that when added to a liquid changes the properties of that liquid at a surface.

Unless otherwise stated, all weight percentages provided herein reflect the weight percentage of the raw material as provided from the manufacturer. The active weight percent of each component is easily determined from the provided information by use of product data sheets as provided from the manufacturer.

### Solid Compositions

In preparing solid compositions, the concentrated degreaser of the invention is formulated to target removal of baked-on and polymerized soils by incorporating a caustic component into the composition.

Solid Composition with Caustic Component

A number of embodiments are provided for solid delivery. These embodiments include a caustic component and as such they are suitable for removal of baked-on or polymerized soils. The formula can be diluted with water to prepare a stable use solution. This caustic based solid embodiment includes an alkalinity source provided by solid sodium hydroxide or solid potassium hydroxide, an amine oxide surfactant blend, a secondary alkalinity source which buffers use solution pH such as sodium or potassium carbonate, powdered or granular chelators, an optional organic secondary alkalinity source (amino methyl propanol, monoethanolamine, triethanolamine, etc.), an optional corrosion inhibitor (metasilicates, silicates, and/or bicarbonates), a long chain alcohol alkoxylate (nonionic) surfactant (or other EO, PO or EO/PO nonionic surfactant), an optional granular or powdered anionic surfactant, and an optional powdered hydrotrope (preferably sodium xylene sulfonate or Stepan Stepanate SXS-93). Microprilled or ground urea (solidifier) and water (for urea occlusion solidification) are optional and are only required if the liquid non-ionic surfactant content of the solid is high enough where a urea-based solidification mechanism is required. The water soluble glycol ether solvents (with flash points >201 degrees F.) and the substantially water insoluble glycol ether solvents (with flash points >201 degrees F.) are also optional. The solid, caustic-based, degreaser can be diluted in water to about 1:1500 by weight, more preferably from about 1:25 to about 1:1000 by weight, and most preferably from about 1:50 to about 1:500 by weight to prepare a use composition or a use solution.

The table below provides component ranges for the solid, caustic, concentrated degreaser embodiment of the invention.

| Tradename | Weight % | Chemical Name |
|---|---|---|
| Lonza Barlox 1260 | 1-10% | N-N Dimethyl-1-dodecyl |
| | | amine-N-oxide, 60% |
| Sodium Metasilicate | 0-15% | Sodium Metasilicate |
| Pentahydrate | | Pentahydrate |
| Sodium Bicarbonate | 0-10% | Sodium Bicarbonate |
| MEA, 99% | 0-5% | Monoethanolamine, 99% |
| Unger AMP-95, 95% | 0-5% | 2-amino-2-methyl-1- |
| | | propanol, 95% solution |
| TEA, 99% | 0-5% | Triethanolamine, 99% |
| Stepan Stepanate SXS-93 | 0.-20% | Sodium Xylene Sulfonate |
| | | powdered, 93% |
| Potassium hydroxide, bead | 5-50% | Potassium hydroxide, bead |
| Sodium hydroxide, bead, | 5-50% | Sodium hydroxide, bead |
| 96% | | |
| Tripropylene Glycol | 0-5% | Tripropylene Glycol |
| Methyl Ether | | Methyl Ether |
| Dipropylene glycol n-butyl | 0-5% | Dipropylene glycol n-butyl |
| ether | | ether |
| Water | 0-15% | Water |
| Urea | 0-60% | Urea |
| Potassium Carbonate | 0.5-50% | Potassium Carbonate |
| Sodium Carbonate | 0.5-50% | Sodium Carbonate |
| Perfume | 0-1% | |
| Dye | 0-1% | |
| Chelator, granular or | 0.5-50% | Chelator, granular or |
| powdered (Akzo Nobel | | powdered (EDTA, GLDA, |
| Dissolvine 220-S [EDTA], | | MGDA, or IDS) |
| Akzo Nobel Dissolvine | | |
| GL-74 [GLDA], BASF | | |
| Trilon M Powder [MGDA], | | |
| or Lanxess Baypure CX- | | |
| 100 [IDS]) | | |
| Sodium Gluconate, | 0-10% | Sodium Gluconate, |
| powdered | | powdered |
| Anionic Surfactant, | 0-50% | Anionic Surfactant, |
| granular, needles or | | granular, needles or |
| powdered (Rhodia | | powdered (SLS or Sodium |
| Rhodapon LS-92/RN [SLS] | | LAS) |
| or Stepan Nacconol 90G | | |
| [Sodium LAS]) | | |
| BASF Plurafac LF 901 | 0.05-20% | Long Chain Alcohol |
| | | Alkoxylate |
| Sodium Acetate, anhydrous | 0-10% | Sodium Acetate, anhydrous |
| PEG 8000 | 0-25% | Polyethylene Glycol, |
| | | MW = 8000 |

Each of the classes of components is described in more detail below.

### Alkali Metal Hydroxide

In the extruded or cast solid embodiments, the solid composition includes an alkali metal hydroxide otherwise referred to as the caustic component. Caustic-based cleaners are useful for saponifying fats, degrading proteins, removing baked-on soils, removing polymerized soils, and removing soils containing heavy pigments. Examples of suitable caustic components include alkali metal hydroxides. Typical examples of alkali metal hydroxides include sodium hydroxide, potassium hydroxide, and lithium hydroxide, also known as the caustic component. In a solid embodiment either sodium hydroxide or potassium hydroxide, or a combination thereof is included in the composition in an amount of from about 0.05 up to about 50 wt %, more preferably 1 up to about 45 wt %, and most preferably 5 up to about 40 wt %.

### Secondary Source of Alkalinity

Soil removal is most commonly obtained from a source of alkalinity used in manufacturing a cleaning composition or degreaser. The term, “secondary source of alkalinity” as used herein refers to a source of alkalinity that is different from the alkali metal hydroxide referenced above. Secondary sources of alkalinity can be organic, inorganic, and mixtures thereof. Organic secondary sources of alkalinity are often strong nitrogen bases including, for example, ammonia (ammonium hydroxide), amines, alkanolamines, and amino alcohols. Typical examples of amines include primary, secondary or tertiary amines and diamines carrying at least one nitrogen linked hydrocarbon group, which represents a saturated or unsaturated linear or branched alkyl group having at least 10 carbon atoms and preferably 16-24 carbon atoms, or an aryl, aralkyl, or alkaryl group containing up to 24 carbon atoms, and wherein the optional other nitrogen linked groups are formed by optionally substituted alkyl groups, aryl group or aralkyl groups or polyalkoxy groups. Typical examples of alkanolamines include monoethanolamine, monopropanolamine, diethanolamine, dipropanolamine, triethanolamine, tripropanolamine and the like. Typical examples of amino alcohols include 2-amino-2-methyl-1-propanol, 2-amino-1-butanol, 2-amino-2-methyl-1,3-propanediol, 2-amino-2-ethyl-1,3-propanediol, hydroxymethyl aminomethane, and the like.

Exemplary sources of secondary inorganic alkalinity also include alkali metal salts, silicates, phosphates, and mixtures thereof. Exemplary alkali metal salts include sodium carbonate, trisodium phosphate, potassium carbonate, and mixtures thereof. Exemplary silicates include sodium metasilicates, sesquisilicates, orthosilicates, silicates, potassium silicates, and mixtures thereof. Exemplary phosphates include sodium tripolyphosphate, tetrapotassium pyrophosphate, sodium pyrophosphate, trisodium phosphate, potassium pyrophosphate, and mixtures thereof. Carbonates and phosphates are known to buffer the pH of water based use solutions.

Additional detergency can be obtained from the use of surfactant materials. Typically, anionic or nonionic surfactants are formulated into such detergents with other ingredients to obtain compositions that can be used to form cleaning solutions having substantial soil removal. A number of optional detergent ingredients can enhance soil removal, but primarily soil removal is obtained from the alkali metal hydroxide and the secondary alkalinity source and the amine oxide, anionic or nonionic surfactant.

In an embodiment for solid delivery of a caustic-based composition, the alkalinity source is comprised of a combination of an amino alcohol such as 2-amino-2-methyl-1-propanol commercially available as AMP-95 from Angus Chemical Company, a subsidiary of The Dow Chemical Company, an alkanolamine, a solid carbonate, and a solid caustic. In an embodiment for extrusion, the alkalinity source is comprised of a combination of alkanolamines, an amino alcohol, solid carbonates, and solid caustics. Up to about 50% of solid sodium hydroxide may be added as the caustic component. Additionally from about 0.05 to 50% by weight of potassium carbonate and/or sodium carbonate may be added.

### Amine Oxide

In addition to the alkali metal hydroxide and the secondary source of alkalinity, an amine oxide surfactant works in conjunction with the alkaline sources to work as the primary degreasing agents in the composition of the present invention.

Active ingredients such as surfactants or surface tension altering compounds or polymers are useful in the present invention. Specifically, surfactants function to alter surface tension in the resulting compositions, provide sheeting action, and assist in soil removal and suspension by emulsifying soil and allowing removal through a subsequent wiping, flushing or rinse. Any number of surfactants may be used including organic surfactants such as anionic surfactants, zwitterionic surfactants, amphoteric surfactants, cationic surfactants and nonionic surfactants. The cleaning agent can be a surfactant or surfactant system, also referred to as a surfactant admixture.

The surfactant or surfactant admixture of the invention includes a tertiary amine oxide. Typical examples of tertiary amine oxides include amine oxides having two C₁₋₅ alkyl groups and one larger C₆₋₃₀ alkyl group. Representative of such materials are dimethyl coco amine oxide, dimethyl lauryl amine oxide, dimethyl decyl amine oxide, dimethyl octyl amine oxide, dimethyl oleyl amine oxide, coco bis ethoxy amine oxide, tallow bis ethoxy amine oxide, bis(2-hydroxy ethyl) cetylamine oxide, bis(2-hydroxy ethyl) tallow amine oxide, bis(2-hydroxy ethyl)hydrogenated tallow amine oxide, bis(2-hydroxy ethyl) stearyl amine oxide, bis(2-hydroxy propyl) tallow amine oxide, bis(2-hydroxy propyl) stearyl amine oxide, dimethyl tallow amine oxide, dimethyl cetyl amine oxide, dimethyl myristyl amine oxide dimethyl stearyl amine oxide, and diethyl stearyl amine oxide. Most preferably the amine oxide blend is a blend of dimethyl lauryl amine oxide, dimethyl myristyl amine oxide, and dimethyl cetyl amine oxide. In a preferred embodiment for delivery upon a substrate, dimethyl lauryl amine oxide commercially available as Barlox 1260 from Lonza Group is useful. Barlox 1260 is a mixture of 3 amine oxides in water and polypropylene glycol. Barlox 1260 contains 41.4% Dimethyl lauryl amine oxide, 15% Dimethyl myristyl amine oxide, 3.6% Dimethyl cetyl amine oxide, 25% polypropylene glycol and 15% water.

In an embodiment the amine oxide as described above is useful in both the extruded and cast solid formulations. Dimethyl lauryl amine oxide commercially available as Barlox 1260 from Lonza Group is useful. The amine oxide is present in the invention in an amount of about 1 up to about 30 percent by weight, 2 up to about 20 wt %, and about 3 up to about 10 wt %

### Surfactant

In addition to the amine oxide, a nonionic surfactant or nonionic surfactant admixture is added to the invention concentrate for delivery methods including the substrate delivery. The particular surfactant or surfactant mixture chosen for use in the process and products of this invention can depend on the conditions of final utility, including method of manufacture, physical product form, use pH, use temperature, foam control, and soil type.

For the purpose of this patent application, the term “nonionic surfactant” typically indicates a surfactant having a hydrophobic group and at least one hydrophilic group comprising a (EO)ₓ group, a (PO)_{y} group, or a (BO)_{z} group wherein x, y and z are numbers that can range from about 1 to about 100. The combination of a generic hydrophobic group and such a hydrophilic group provides substantial surfactancy to such a composition. Examples of suitable types of nonionic surfactant include the polyethylene oxide condensates of alkyl phenols. These compounds include the condensation products of alkyl phenols having an alkyl group containing from about 6 to 12 carbon atoms in either a straight chain or branched chain configuration, with ethylene oxide. Ethylene oxide being present in amounts equal to 5 to 20 moles of ethylene oxide per mole of alkyl phenol. Examples of compounds of this type include nonyl phenol condensed with an average of about 9.5 moles of ethylene oxide per mole of nonyl phenol, dodecyl phenol condensed with about 12 moles of ethylene oxide per mole of phenol, dinonyl phenol condensed with about 15 moles of ethylene oxide per mole of phenol, diisoctylphenol condensed with about 15 moles of ethylene oxide per mole of phenol.

The condensation products of aliphatic alcohols with ethylene oxide can also exhibit useful surfactant properties. The alkyl chain of the aliphatic alcohol may either be straight or branched and generally contains from about 3 to about 22 carbon atoms. Preferably, there are from about 3 to about 18 moles of ethylene oxide per mole of alcohol. The polyether can be conventionally end capped with acyl groups including methyl, benzyl, etc. groups. Examples of such ethoxylated alcohols include the condensation product of about 6 moles of ethylene oxide with 1 mole of tridecanol, myristyl alcohol condensed with about 10 moles of ethylene oxide per mole of myristyl alcohol, the condensation product of ethylene oxide with coconut fatty alcohol wherein the coconut alcohol is a mixture of fatty alcohols with alkyl chains varying from 10 to 14 carbon atoms and wherein the condensate contains about 6 moles of ethylene oxide per mole of alcohol, and the condensation product of about 9 moles of ethylene oxide with the above-described coconut alcohol. Examples of commercially available nonionic surfactants of this type include Tergitol 15-S-9 marketed by DOW and Tomadol 91-6 and Tomadol 1-5 marketed by the Air Products.

The condensation products of ethylene oxide with a hydrophobic base formed by the condensation of propylene oxide with propylene glycol can be used. The hydrophobic portion of these compounds has a molecular weight of from about 1,500 to 1,800 and of course exhibits water insolubility. The addition of polyoxyethylene moieties to this hydrophobic portion tends to increase the water solubility of the molecule as a whole, and the liquid character of the product is retained up to the point where the polyoxyethylene content is about 50% of the total weight of the condensation product. Examples of compounds of this type include certain of the commercially available Pluronic and Plurafac surfactants marketed by BASF.

Nonionic surfactants may include alcohol alkoxylates having EO, PO and BO blocks. Straight chain primary aliphatic alcohol alkoxylates can be particularly useful as non-ionic surfactants. Such alkoxylates are also available from several sources including BASF where they are known as “Plurafac” and “Pluronic” surfactants. A particular group of alcohol alkoxylates found to be useful are those having the general formula R-(EO)ₘ—(PO)ₙ wherein m is an integer from about 2 to 10 and n is an integer from about 2 to 20. R can be any suitable radical such as a straight chain alkyl group having from about 6 to 20 carbon atoms. Such nonionic surfactants, preferably alcohol alkoxylates, are present in the invention in liquid delivery suitable for coating on a substrate an amount of up to about 40 percent by weight.

Other useful nonionic surfactants include capped aliphatic alcohol alkoxylates. These end caps include but are not limited to methyl, ethyl, propyl, butyl, benzyl and chlorine. Useful alcohol alkoxylates include ethylene diamine ethylene oxides, ethylene diamine propylene oxides, mixtures thereof, and ethylene diamine EO-PO compounds, including those sold under the tradename Tetronic. Preferably, such surfactants have a molecular weight of about 400 to 10,000. Capping improves the compatibility between the nonionic and the oxidizers hydrogen peroxide and peroxycarboxylic acid, when formulated into a single composition. Other useful nonionic surfactants are alkylpolyglycosides. The alcohol alkoxylates can be linear, branched or a combination of linear and branched. The alcohol alkoxylates can also be secondary alcohol alkoxylates. Mixtures of the above surfactants are also useful in the present invention.

Although alcohol alkoxylates are preferred, one skilled in the art will recognize that other nonionic surfactants may be incorporated into the compositions of the present invention instead of the alcohol alkoxylates.

In the extruded and cast solid embodiments, alcohol alkoxylates are preferably included as the nonionic surfactant. Alcohol alkoxylates are present in amounts from about 0.05 up to about 30% by weight, more preferably 0.1 up to about 27%, and most preferably from about 1 up to about 25% by weight. The alcohol alkoxylate assists as a hardening agent in solidifying the composition when combined with urea and water.

Other useful nonionic surfactants can comprise a silicone surfactant including a modified dialkyl, preferably a dimethyl polysiloxane. The polysiloxane hydrophobic group is modified with one or more pendent hydrophilic polyalkylene oxide group or groups. Such surfactants provide low surface tension, high wetting, antifoaming and excellent stain removal. U.S. Pat. No. 7,199,095 incorporated herein by reference for all purposes in its entirety teaches use of such silicone nonionic surfactants in a detergent composition. Such silicone surfactants comprise a polydialkyl siloxane, preferably a polydimethyl siloxane to which polyether, typically polyethylene oxide, groups have been grafted through a hydrosilation reaction. The process results in an alkyl pendent (AP type) copolymer, in which the polyalkylene oxide groups are attached along the siloxane backbone through a series of hydrolytically stable Si—C bond.

A second class of nonionic silicone surfactants is an alkoxy-end-blocked (AEB type) that are less preferred because the Si—O— bond offers limited resistance to hydrolysis under neutral or slightly alkaline conditions, but breaks down quickly in acidic environments.

Examples of silicone surfactants are sold under the SILWET® trademark from Momentive Performance Materials or under the TEGOPREN® trademark from Evonik Industries.

In addition to non-ionic surfactants, anionic surfactants or an anionic surfactant admixture are optionally included in the solid compositions. The term “anionic surfactant” includes any surface active substances which are categorized as anionics because the charge on the hydrophobe is negative; or surfactants in which the hydrophobic section of the molecule carries no charge unless the pH is elevated to neutrality or above (e.g. carboxylic acids). Carboxylate, sulfonate, sulfate and phosphate are the polar (hydrophilic) solubilizing groups found in anionic surfactants. Of the cations (counter ions) associated with these polar groups, sodium, lithium and potassium impart water solubility; ammonium and substituted ammonium ions provide both water and oil solubility; and calcium, barium, and magnesium promote oil solubility.

As those skilled in the art understand, anionics are excellent detersive surfactants and are therefore, favored additions to heavy duty detergent compositions. Anionics are useful additives to compositions of the present invention. Further, anionic surface active compounds are useful to impart special chemical or physical properties other than detergency within the composition. Anionics are excellent solubilizers and can be used for hydrotropic effect and cloud point control.

The majority of large volume commercial anionic surfactants can be subdivided into five major chemical classes and additional sub-groups known to those of skill in the art and described in “Surfactant Encyclopedia,” Cosmetics & Toiletries, Vol. 104 (2) 71 86 (1989). The first class includes acylamino acids (and salts), such as acylgluamates, acyl peptides, sarcosinates (e.g. N-acyl sarcosinates), taurates (e.g. N-acyl taurates and fatty acid amides of methyl tauride), and the like. The second class includes carboxylic acids (and salts), such as alkanoic acids (and alkanoates), ester carboxylic acids (e.g. alkyl succinates), ether carboxylic acids, and the like. The third class includes phosphoric acid esters and their salts. The fourth class includes sulfonic acids (and salts), such as isethionates (e.g. acyl isethionates), alkylaryl sulfonates, alkyl sulfonates, sulfosuccinates (e.g. monoesters and diesters of sulfosuccinate), and the like. The fifth class includes sulfuric acid esters (and salts), such as alkyl ether sulfates, alkyl sulfates, and the like.

Anionic sulfate surfactants suitable for use in the present compositions include the linear and branched primary and secondary alkyl sulfates, alkyl ethoxysulfates, fatty oleyl glycerol sulfates, alkyl phenol ethylene oxide ether sulfates, the C₅ C₁₇ acyl-N—(C₁ C₄ alkyl) and —N—(C₁ C₂ hydroxyalkyl) glucamine sulfates, and sulfates of alkylpolysaccharides such as the sulfates of alkylpolyglucoside (the nonionic nonsulfated compounds being described herein).

Examples of suitable synthetic, water soluble anionic detergent compounds include the ammonium and substituted ammonium (such as mono-, di- and triethanolamine) and alkali metal (such as sodium, lithium and potassium) salts of the alkyl mononuclear aromatic sulfonates such as the alkyl benzene sulfonates containing from 5 to 18 carbon atoms in the alkyl group in a straight or branched chain, e.g., the salts of alkyl benzene sulfonates or of alkyl toluene, xylene, cumene and phenol sulfonates; alkyl naphthalene sulfonate, diamyl naphthalene sulfonate, and dinonyl naphthalene sulfonate and alkoxylated derivatives.

Anionic carboxylate surfactants suitable for use in the present compositions include the alkyl carboxylates, alkyl ethoxy carboxylates, and the alkyl polyethoxy polycarboxylate surfactants.

Other anionic detergents suitable for use in the present compositions include olefin sulfonates, such as long chain alkene sulfonates, long chain hydroxyalkane sulfonates or mixtures of alkenesulfonates and hydroxyalkane-sulfonates. Also included are the alkyl sulfates, alkyl poly(ethyleneoxy) ether sulfates and aromatic poly(ethyleneoxy) sulfates such as the sulfates or condensation products of ethylene oxide and nonyl phenol (usually having 1 to 6 oxyethylene groups per molecule). Resin acids and hydrogenated resin acids are also suitable, such as rosin, hydrogenated rosin, and resin acids and hydrogenated resin acids present in or derived from tallow oil.

When present, anionic surfactants are preferably sodium linear alkylbenzene sulfonate or sodium lauryl sulfate, and preferably in an amount up to 50% by weight.

In solid compositions, granular, powdered, or needles of anionic surfactants are optionally present. Anionic surfactants are preferably granular or powdered sodium linear alkylbenzene sulfonates (such as Stepan's Nacconol 90G), or granular, powdered or needles of sodium lauryl sulfate (such as Rhodia Novacare's Rhodapon LS-92/RN). Granular, powdered or needles of anionic surfactants are present in similar amounts of up to about 50% by weight, more preferably up to about 45%, and most preferably up to about 40% by weight.

### Solvent

A solvent is useful in the composition of the invention to enhance certain soil removal properties. The compositions of the invention can contain a non-aqueous or aqueous solvent. Preferred solvents are non-aqueous oxygenated solvents. Oxygenated solvents include lower alkanols, lower alkyl ethers, glycols, aryl glycol ethers and lower alkyl glycol ethers. These materials are colorless liquids with mild pleasant odors, are excellent solvents and coupling agents and may be miscible with aqueous use compositions of the invention. Examples of useful solvents include methanol, ethanol, propanol, isopropanol and butanol, isobutanol, ethylene glycol, diethylene glycol, triethylene glycol, propylene glycol, dipropylene glycol, mixed ethylene-propylene glycol ethers, ethylene glycol phenyl ether, and propylene glycol phenyl ether. Substantially water soluble glycol ether solvents include propylene glycol methyl ether, propylene glycol propyl ether, dipropylene glycol methyl ether, tripropylene glycol methyl ether, ethylene glycol butyl ether, diethylene glycol methyl ether, diethylene glycol butyl ether, ethylene glycol dimethyl ether, ethylene glycol propyl ether, diethylene glycol ethyl ether, triethylene glycol methyl ether, triethylene glycol ethyl ether, triethylene glycol butyl ether, and others. “Substantially water soluble” solvents are defined as being infinitely or 100% soluble by weight in water at 25 degrees C. “Substantially water insoluble” glycol ether solvents include propylene glycol butyl ether, dipropylene glycol butyl ether, dipropylene glycol propyl ether, tripropylene glycol butyl ether, dipropylene glycol dimethyl ether, propylene glycol phenyl ether, ethylene glycol hexyl ether, diethylene glycol hexyl ether, ethylene glycol phenyl ether, diethylene glycol phenyl ether, and others. “Substantially water insoluble” solvents are defined as 53% by weight or less of solvent is soluble in water at 25 degrees C. Preferred solvents are a substantially water-soluble solvents. These preferred solvents help reduce surface tension, help solubilize grease, and help to maintain the cleaner as a stable single phase system. For reasons of low cost, commercial availability, high flash point, and solvent strength, diethylene glycol monobutyl ether is a preferred solvent.

### Additional Ingredients

Any number of optional ingredients may be added to the extruded or cast solid composition of the invention. If the solid will be diluted with hard water, as opposed to soft water, a chelating agent is a desirable optional ingredient. If a water insoluble solvent and/or a water insoluble non-ionic surfactant is included, a hydrotrope is preferably included to help maintain a uniform stable liquid solution after dilution. Preservatives, fragrance and dye are examples of further ingredients that are optionally added to the concentrate composition of the invention. These additional optional ingredients are discussed in turn in more detail below.

### Hydrotrope

Hydrotropy is a property that relates to the ability of materials to improve the solubility or miscibility of a substance in liquid phases in which the substance tends to be insoluble. Substances that provide hydrotropy are called hydrotropes and are used in relatively lower concentrations than the materials to be solubilized. A hydrotrope modifies a formulation to increase the solubility of an insoluble substance or creates micellar or mixed micellar structures resulting in a stable suspension of the insoluble substance. The hydrotropic mechanism is not thoroughly understood. Apparently either hydrogen bonding between primary solvent, in this case water, and the insoluble substance are improved by the hydrotrope or the hydrotrope creates a micellar structure around the insoluble composition to maintain the material in a suspension/solution. In this invention it is believed that the hydrotropes are most useful in maintaining a stable end-use water-based solution when the solid composition is dispensed at the use location, where water insoluble solvents or water insoluble non-ionic surfactants are present in the embodiment.

Hydrotrope materials are relatively well known to exhibit hydrotropic properties in a broad spectrum of chemical molecule types. Hydrotropes generally include ether compounds, alcohol compounds, anionic surfactants, cationic surfactants and other materials. Hydrotropes are used in detergent formulations to allow more concentrated formulations of surfactants. A hydrotrope is a compound that solubilizes hydrophobic compounds in aqueous solutions.

In addition, when a water insoluble surfactant and/or a water insoluble solvent is included in the composition of the present invention, it has been found that aromatic sulfonic acids or salts thereof are useful hydrotropes. Examples of such hydrotropes are xylene sulfonic acid, naphthalene sulfonic acid, cumene sulfonic acid, and toluene sulfonic acid or sodium and ammonium salts thereof. In particular, a solid or powdered form of a hydrotrope may optionally be included such as sodium xylene sulfonate as available from Stepan as Stepanate SXS-93. In an embodiment of the invention the hydrotrope is present in an amount from about 0 up to about 20 weight percent. Other powdered or granular hydrotropes are also useful.

### Chelating Agent

The active cleaning compositions of the invention can comprise a polyvalent metal complexing, sequestering or chelating agent that aids in metal compound soil removal and in reducing harmful effects of hardness components in service water. Typically, a polyvalent metal cation or compound such as a calcium, a magnesium, an iron, a manganese, a molybdenum, etc. cation or compound, or mixtures thereof, can be present in service water and in complex soils. Such compounds or cations can comprise a stubborn soil or can interfere with the action of either washing compositions or rinsing compositions during a cleaning regimen. A chelating agent can effectively complex and remove such compounds or cations from soiled surfaces and can reduce or eliminate the inappropriate interaction with active ingredients including the nonionic surfactants and anionic surfactants of the invention. Both organic and inorganic chelating agents are common and can be used. Inorganic chelating agents include such compounds as sodium tripolyphosphate and other higher linear and cyclic polyphosphates species. Organic chelating agents include both polymeric and small molecule chelating agents. Organic small molecule chelating agents are typically organocarboxylate compounds or organophosphate chelating agents. Polymeric chelating agents commonly comprise polyanionic compositions such as polyacrylic acid compounds. Small molecule organic chelating agents include sodium gluconate, sodium glucoheptonate, N-hydroxyethylenediaminetriacetic acid (HEDTA), ethylenediaminetetraacetic acid (EDTA), nitrilotriaacetic acid (NTA), diethylenetriaminepentaacetic acid (DTPA), ethylenediaminetetraproprionic acid, triethylenetetraminehexaacetic acid (TTHA), and the respective alkali metal, ammonium and substituted ammonium salts thereof, ethylenediaminetetraacetic acid tetrasodium salt (EDTA), nitrilotriacetic acid trisodium salt (NTA), ethanoldiglycine disodium salt (EDG), diethanolglycine sodium-salt (DEG), and 1,3-propylenediaminetetraacetic acid (PDTA), dicarboxymethyl glutamic acid tetrasodium salt (GLDA), methylglycine-N—N-diacetic acid trisodium salt (MGDA), and iminodisuccinate sodium salt (IDS). All of these are known and commercially available. Small molecule organic chelating agents also include biodegradable sequestrants having combinations of chelating and hydrotroping functionalities from EDG, MGDA and GLDA-type molecules. Sodium gluconate is an especially useful sequestrant by chelating iron ions present as an impurity in inorganic alkalinity sources. Preferred sequestrants include ethylenediaminetetraacetic acid tetrasodium salt (EDTA), dicarboxymethyl glutamic acid tetrasodium salt (GLDA), and methylglycine-N—N-diacetic acid trisodium salt (MGDA), iminodisuccinate sodium salt (IDS), and sodium gluconate due to their availability in powdered or granular form.

In an embodiment of the invention, an optional chelating agent is granular or powdered and is preferably ethylenediaminetetraacetic acid tetrasodium salt (EDTA), dicarboxymethyl glutamic acid tetrasodium salt (GLDA), methylglycine-N—N-diacetic acid trisodium salt (MGDA), iminodisuccinate sodium salt (IDS), sodium gluconate, or a combination thereof in an amount from about 0.05 to about 50 wt %, more preferably from about 5 to about 45 wt %, and most preferably 10 to about 40 wt %.

### Corrosion Inhibitor

A corrosion inhibitor is a chemical compound that, when added in small concentrations, stops or slows down corrosion, otherwise referred to as oxidation of metals and alloys. Examples of suitable corrosion inhibitors include those that inhibit corrosion, but that do not significantly interfere with the solubilizing activity of the composition. Corrosion inhibitors which may be optionally added to the composition of the invention include silicates, phosphate, magnesium and/or zinc ions. Preferably, the metal ions are provided in a water-soluble form. Examples of useful water-soluble forms of magnesium and zinc ions are the water-soluble salts thereof including the chlorides, nitrates and sulfates of the respective metals. Some preferred corrosion inhibitors include sodium metasilicate, sodium bicarbonate, potassium silicate and/or sodium silicate. Corrosion inhibitors useful in the present invention, regardless of delivery method, are sodium metasilicate pentahydrate and/or sodium bicarbonate.

When a corrosion inhibitor is present in the invention composition suitable for solid delivery it is added in an amount of up to about 25 weight percent more preferably up to about 20 wt %, and most preferably up to about 15 wt %.

### Dyes, Fragrances and Preservatives

Aesthetic enhancing agents such as dye and perfume are also optionally incorporated into the concentrate composition of the invention. Examples of dyes useful in the present invention include but are not limited to liquid and powdered dyes from Milliken Chemical, Keystone, Clariant, Spectracolors and Pylam. In a preferred embodiment, Liquitint Brilliant Orange commercially available from Milliken Chemical is used. In preferred solid embodiments up to about 1 wt % is included, more preferably up to about 0.95 wt %, and most preferably up to about 0.90 wt %.

Examples of perfumes or fragrances useful in concentrate compositions of the invention include but are not limited to liquid fragrances from J&E Sozio, Firmenich, and IFF (International Flavors and Fragrances). In embodiments of the invention Orange Fragrance SZ-40173 commercially available from J&E Sozio is included up to about 1 wt %, more preferably up to about 0.95 wt % and most preferably up to about 0.90 wt %.

Preservatives are required when the concentrate and use solution pH is not high enough to mitigate bacterial growth in the solid composition or in the use solution. Examples of preservatives useful in concentrate compositions of the invention include but are not limited to methyl paraben, glutaraldehyde, formaldehyde, 2-bromo-2-nitropropane-1,3-diol, 5-chloro-2-methyl-4-isothiazoline-3-one, and 2-methyl-4-isothiazoline-3-one. Preservatives can be included up to about 2 wt %, more preferably up to about 1 wt % and most preferably up to about 0.5 wt %.

### Hardening Agents

Other components which may be used in solid delivery formats of the present invention include hardening agents such as urea, also known as carbamide, polyethylene glycols (PEG) with molecular weights of 1000 and greater, polypropylene glycols (PPG) with molecular weights of 1000 and greater, and starches which have been made water soluble through an acid or alkaline treatment. Also useful are various inorganics that either impart solidifying properties to the present composition and can be processed into pressed tablets for carrying the alkaline agent. Such inorganic agents include calcium carbonate, magnesium sulfate, sodium sulfate, sodium bisulfate, alkali metal phosphates, sodium acetate and other known hydratable compounds Anhydrous versions of these hydratable compounds are preferred. We have also found a novel hardening or binding agent for alkaline metal carbonate detergent compositions. We believe the binding agent comprises an amorphous complex of an organic phosphonate compound, sodium carbonate, and water. The proportions of this binding hardening agent are disclosed in U.S. Pat. No. 6,177,392 which is incorporated by reference herein in its entirety for all purposes. This carbonate phosphate water binding agent can be used in conjunction with other hardening agents such as a nonionic surfactant for example. U.S. Pat. Nos. 6,124,250; 6,608,023; 6,649,586; 7,037,886; 7,341,987; 7,423,005; and 7,442,679 all incorporated herein by reference in their entirety for all purposes all further disclose hardening agents and methods useful in preparing solid delivery format compositions of the present invention.

Urea occlusion is another means of solidification which combines urea, water and a non-ionic surfactant to form a structure within the solid which binds the remaining ingredients. The proportions of this binding agent blend are disclosed in U.S. Pat. No. 4,624,713 which is incorporated by reference herein in its entirety for all purposes.

### Water

The extruded or cast solid compositions of the invention are substantially nonaqueous. While it is recognized that certain ingredients may contain some amount of water because either they are provided as a solution in water or are a hydrated salt, the solid compositions still remain substantially nonaqueous.

Additional water is sometimes added with urea and non-ionic surfactant to solidify the composition via urea occlusion. In such embodiments, up to about 15 percent by weight water is added.

It should be understood that the water provided as part of the solid composition, if any, can be relatively free of hardness. It is expected that the water can be deionized to remove a portion of the dissolved solids. The concentrate is then diluted with water available at the locale or site of dilution and that water may contain varying levels of hardness depending upon the locale. Although deionized is preferred for formulating the concentrate, the concentrate can be formulated with water that has not been deionized. That is, the concentrate can be formulated with water that includes dissolved solids, and can be formulated with water that can be characterized as hard water.

Service water available from various municipalities has varying levels of hardness. It is generally understood that the calcium, magnesium, iron, manganese, or other polyvalent metal cations that may be present can cause precipitation of the anionic surfactant. In general, because of the expected large level of dilution of the concentrate to provide a use solution, it is expected that service water from certain municipalities will have a greater impact on the potential for anionic surfactant precipitation than the water from other municipalities. As a result, it is desirable to provide a concentrate that can handle the hardness levels found in the service water of various municipalities. The water of dilution that can be used to dilute the concentrate can be characterized as hard water when it includes at least 1 grain hardness. It is expected that the water of dilution can include at least 5 grains hardness, at least 10 grains hardness, or at least 20 grains hardness.

It is expected that the solid composition will be diluted with the water of dilution in order to provide a use solution having a desired level of detersive properties. If the use solution is required to remove tough or heavy soils, it is expected that the solid composition can be diluted with the water of dilution at a weight ratio of at least 1:10. If a light duty cleaning use solution is desired, it is expected that the solid composition can be diluted at a weight ratio of concentrate to water of dilution of up to about 1:1000. It is expected that the weight ratio of concentrate to water of dilution will be between about 1:10 and about 1:500, between about 1:20 and about 1:450, between about 1:30 and about 1:400, and between about 1:40 and about 1:350. In certain preferred solid delivery applications including caustic components, the concentrate can be diluted at a weight ratio of concentrate to water of dilution at about 1:10 to 1:500 by weight to provide a cleaner/degreaser.

Compositions of the invention are useful in preparing stable use compositions. By use of the term, “stable” it is meant that use compositions or use solutions prepared with dilution water and solid compositions of the invention are phase stable and remain in solution. That is, the solid does not resolidify or precipitate out of solution once a use solution is prepared. A stable use solution is said to remain in solution and phase stable, that is, it does not separate into two phases, for at least 1 week, at least 2 weeks, at least 3 weeks, and at least up to 4 weeks when stored at ambient conditions of 60 to 80 degrees Fahrenheit.

The compositions may further include anti-microbial agents, enzymes, enzyme stabilizing system, bleaching agents, secondary hardening agent, defoamer, anti-redeposition agent, and the like.

### Delivery Modes

The concentrate composition of the invention may be provided in a packaged form wherein the package is comprised of a tub, bottle, pre-formed tray, blown or vacuum formed film container, film pouch or capsule. The packaged solid composition can be placed in a water soluble or non-water soluble polymer container. In the case of a non-water soluble container, the film can be torn or cut, or the container's lid removed to release the solid composition. The solid composition can then be introduced into a volume of water. When the film is a water soluble film (or a water-dispersible film) or water soluble capsule, the packaged composition concentrate can be introduced into a volume of water and, with time, the film dissolves, disintegrates, or disperses, and the composition concentrate contacts the water.

Non-water soluble films that can be used to hold or contain the cleaning composition concentrate include conventional films used in the packaging industry. Exemplary films that can be used include polyethylenes, polypropylenes, polybutylenes, polyesters, and polyamides.

Water soluble (or water dispersible) films or capsules that can be used include those made from water soluble polymers such as those described in Davidson and Sittig, Water Soluble Resins, Van Nostrand Reinhold Company, New York (1968), herein incorporated by reference. The water soluble polymers can have proper characteristics such as strength and pliability in order to permit machine handling. Exemplary water soluble polymers include polyvinyl alcohol, cellulose ethers, polyethylene oxide, starch, polyvinylpyrrolidone, polyacrylamide, polyvinyl methyl ether-maleic anhydride, polymaleic anhydride, styrene maleic anhydride, hydroxyethylcellulose, methylcellulose, polyethylene glycols, carboxymethylcellulose, polyacrylic acid salts, alginates, acrylamide copolymers, guar gum, casein, ethylene-maleic anhydride resin series, polyethyleneimine, ethyl hydroxyethylcellulose, ethyl methylcellulose, and hydroxyethyl methylcellulose. Lower molecular weight water soluble, polyvinyl alcohol film-forming polymers are generally, preferred. Polyvinyl alcohols that can be used include those having a weight average molecular weight of between about 1,000 and about 300,000, and between about 2,000 and about 150,000, and between about 3,000 and about 100,000.

Exemplary water soluble packaging films are disclosed in U.S. Pat. Nos. 6,503,879; 6,228,825; 6,303,553; 6,475,977; and 6,632,785, the disclosures of which are incorporated herein by reference for all purposes. In addition, see U.S. Pat. No. 4,474,976 to Yang, U.S. Pat. No. 4,692,494 to Sonenstein, U.S. Pat. No. 4,608,187 to Chang, U.S. Pat. No. 4,416,793 to Haq, U.S. Pat. No. 4,348,293 to Clarke, U.S. Pat. No. 4,289,815 to Lee, and U.S. Pat. No. 3,695,989 to Albert, the disclosures of which are all incorporated herein by reference for all purposes. An exemplary water soluble polymer that can be used to package the concentrate includes polyvinyl alcohol.

In one embodiment of the invention, the composition concentrate is provided as a capsule, tablet or pellet of compressed powder, a solid, or loose powder, either contained by a water soluble material or not. In the case of providing the capsule, tablet or pellet of the composition in a material, the capsule, tablet or pellet can be introduced into a volume of water, and if present the water soluble material can solubilize, degrade, or disperse to allow contact of the composition concentrate with the water. The capsule, tablet or pellet can be advantageous because it may be easier to introduce the capsule through certain geometric configurations such as, the neck of a bottle (e.g., a spray bottle). Accordingly, when one has exhausted or nearly exhausted the contents of a spray bottle containing a cleaning composition, one can fill the spray bottle with water and insert the capsule, tablet or pellet into the spray bottle, or one can introduce the capsule into the spray bottle and then fill the spray bottle with water. The solid can be formed into a capsule, tablet or pellet shape. The solid can have a capsule material surrounding the solid with can be composed of a water soluble polymer or water dispersible polymer as discussed previously. For the purposes of this disclosure, the terms “capsule”, “tablet” and “pellet” are used for exemplary purposes and are not intended to limit the delivery mode of the invention to a particular shape.

In yet another embodiment, the concentrate composition can be provided in a solid form that resists crumbling or other degradation until placed into a container. Such container may either be filled with water before placing the composition concentrate into the container, or it may be filled with water after the composition concentrate is placed into the container. In either case, the solid concentrate composition dissolves, solubilizes, or otherwise disintegrates upon contact with water. In a preferred embodiment, the solid concentrate composition dissolves rapidly thereby allowing the concentrate composition to become a use composition and further allowing the end user to apply the use composition to a surface in need of cleaning.

In another embodiment, the solid concentrate composition can be diluted through dispensing equipment whereby water is sprayed at the solid block forming the use solution. The water flow is delivered at a relatively constant rate using mechanical, electrical, or hydraulic controls and the like. The solid concentrate composition can also be diluted through dispensing equipment whereby water flows around the solid block, creating a use solution as the solid concentrate dissolves. The solid concentrate composition can also be diluted through pellet, tablet, powder and paste dispensers, and the like.

### Solidification Process

The manufacture and use of solid block cleaning compositions were pioneered in technology disclosed in Fernholz et al., U.S. Reissue Pat. Nos. 32,763 and 32,818 and in Heile et al., U.S. Pat. Nos. 4,595,520 and 4,680,134 and are hereby incorporated by reference in their entirety for all purposes. In the manufacture of solid detergents, various hardening mechanisms have been used in the manufacture of cleaning and sanitizing compositions for the manufacture of the solid block. Active ingredients are often combined with a hardening agent under conditions that convert the hardening agent from a liquid to a solid rendering the solid material into a mechanically stable block format. One type of such hardening systems suitable for the present invention is a molten process disclosed in the Fernholz patents. A sodium hydroxide hydrate, having a melting point of about 55 degrees to 60 degrees C., acts as a hardening agent. In the manufacturing process, a molten sodium hydroxide hydrate liquid melt is formed into which is introduced solid particulate materials. A suspension or solution of the solid particulate materials in the molten caustic is formed and is introduced into plastic bottles called capsules, also called container shaped molds, for solidification. The material cools, solidifies and is ready for use. The suspended or solubilized materials are evenly dispersed throughout the solid and are dispensed with the caustic cleaner.

A process such as that disclosed in Heile et al. could be used in manufacture of a solid composition of the invention. An anhydrous carbonate or an anhydrous sulfate salt is hydrated in the process forming a hydrate, having a melting point of about 55 degrees C., that comprises proportions of monohydrate, heptahydrate and decahydrate solid. The carbonate hydrate is used similarly to the caustic hydrate of Fernholz et al. to make a solid block multicomponent detergent. Other examples of such molten processes include Morganson, U.S. Pat. No. 4,861,518 incorporated herein by reference in its entirety for all purposes which teaches a solid cleaning concentrate formed by heating an ionic and nonionic surfactant system with the hardening agent such as polyethylene glycol, at temperatures that range greater than about 38 degrees C. to form a melt. Such a melt is combined with other ingredients to form a homogeneous dispersion that is then poured into a mold to harden. Morganson et al, U.S. Pat. No. 5,080,819 incorporated herein by reference in its entirety for all purposes teaches a highly alkaline cast solid composition adapted for use at low temperature warewashing temperatures using effective cleaning amounts of a nonionic surfactant to enhance soil removal. Gladfelter, U.S. Pat. No. 5,316,688 incorporated herein by reference in its entirety for all purposes teaches a solid block alkaline detergent composition wrapped in a water soluble or water dispersible film packaging.

Solid pelletized materials as shown in Gladfelter, U.S. Pat. Nos. 5,078,301, 5,198,198 and 5,234,615 and in Gansser U.S. Pat. Nos. 4,823,441 and 4,931,202 all incorporated herein by reference in their entirety for all purposes are useful in preparing a solid composition of the present invention. Such pelletized materials are typically made by extruding a molten liquid or by compressing a powder into a tablet or pellet as commonly known in the art. Extruded nonmolten alkaline detergent materials are disclosed in Gladfelter et al., U.S. Pat. No. 5,316,688 also incorporated herein by reference in its entirety for all purposes.

Urea occlusion solidification as shown in U.S. Pat. No. 4,624,713 to Morganson et al. is useful in preparing a solid composition of the present invention. Hardeners such as anhydrous sodium acetate and the like, are useful materials in forming a solid concentrate composition. The use of solidifiers or hardeners allows for a higher level of liquid actives to be incorporated into the solid concentrate composition.

While the invention is amenable to various modifications and alternative forms, specifics thereof have been shown by way of the Examples and will be described in detail. It should be understood, however, that the intention is not to limit the invention to the particular embodiments described. On the contrary, the intention is to cover all modifications, equivalents, and alternatives falling within the spirit and scope of the invention.

### Example 1

Cast solid formulations including caustic components and having the compositions provided in Table 1 below were prepared.

TABLE 1

| | | | % by | | |
|---|---|---|---|---|---|
| | | | weight | | |
| Chemical | Category | Tradename | Comp. A | Comp. M | Comp. N |
| Amine oxide - 60% | Surfactant | Lonza Barlox 1260 | 5.00 | 5.00 | 5.00 |
| actives | | | | | |
| Sodium Metasilicate | Corrosion | Sodium Metasilicate | 3.50 | 3.50 | 3.50 |
| Pentahydrate | Inhibitor | Pentahydrate | | | |
| Monoethanolamine, 99% | Alkalinity Source | Monoethanolamine, | — | 2.00 | — |
| | | 99% | | | |
| Sodium hydroxide, 96% | Alkalinity Source | Sodium hydroxide | 20.00 | 20.00 | 20.00 |
| minimum | | bead | | | |
| Sodium Gluconate, | Chelator | Sodium Gluconate, | 0.75 | 0.75 | 0.75 |
| powdered | | powdered | | | |
| Sodium Carbonate | Alkalinity Source | Sodium Carbonate | 9.45 | 9.45 | 9.45 |
| Perfume | Perfume | J&E Sozio Orange | 0.20 | 0.20 | 0.20 |
| | | Fragrance SZ-40173 | | | |
| Dye | Dye | Liquitint Brilliant | 0.20 | 0.20 | 0.20 |
| | | Orange | | | |
| Ethylenediaminetetraacetic | Chelator | Akzo Nobel | 25.00 | 25.00 | 25.00 |
| acid tetrasodium salt, 99% | | Dissolvine 220-S | | | |
| minimum | | | | | |
| Amino methyl propanol- | Alkalinity Source | Unger AMP 95 | 2.00 | — | — |
| 95% | | | | | |
| Long Chain Alcohol | Non-ionic | BASF Plurafac LF | 13.72 | 13.72 | 15.72 |
| Alkoxylate | Surfactant | 901 | | | |
| Polyethylene glycol MW = | Hardening agent | PEG 8000 | 17.18 | 17.18 | 17.18 |
| 8000 | | | | | |
| Sodium acetate, anhydrous | Hardening agent | Sodium acetate, | 3.00 | 3.00 | 3.00 |
| | | anhydrous | | | |

The solid concentrates in Example 1 were made by melting the polyethylene glycol, and then adding all of the liquid materials. All of the liquid materials were thoroughly mixed together until uniform. All of the granular and powdered materials were added and then mixed until uniform. The composition was poured into forms and allowed to harden. Once hardened, the composition was removed from the form to create a cast solid block.

### Example 2

Extruded solid formulations including high concentrations of caustic components and having the compositions provided in Table 2 below were prepared.

TABLE 2

| | | | % by weight | | |
|---|---|---|---|---|---|
| Chemical | Category | Tradename | Composition P | Composition L | Composition Q |
| Amine oxide - 60% | Surfactant | Lonza Barlox 1260 | 7.00 | 7.00 | 7.00 |
| actives | | | | | |
| Sodium Metasilicate | Corrosion | Sodium | 3.50 | 3.50 | 3.50 |
| Pentahydrate | Inhibitor | Metasilicate | | | |
| | | Pentahydrate | | | |
| Sodium hydroxide, 96% | Alkalinity | Sodium hydroxide | 30.00 | 30.00 | 30.00 |
| minimum | Source | bead | | | |
| Sodium Gluconate, | Chelator | Sodium Gluconate, | 1.00 | 1.00 | 1.00 |
| powdered | | powdered | | | |
| Sodium Carbonate | Alkalinity | Sodium Carbonate | 22.80 | 22.80 | 22.80 |
| | Source | | | | |
| Perfume | Perfume | J&E Sozio Orange | 0.50 | 0.50 | 0.50 |
| | | Fragrance SZ- | | | |
| | | 40173 | | | |
| Dye | Dye | Liquitint Brilliant | 0.20 | 0.20 | 0.20 |
| | | Orange | | | |
| Ethylenediaminetetraacetic | Chelator | Akzo Nobel | 25.00 | 25.00 | 25.00 |
| acid tetrasodium salt, 99% | | Dissolvine 220-S | | | |
| minimum | | | | | |
| Amino methyl propanol- | Alkalinity | Unger AMP 95 | 2.00 | — | — |
| 95% | Source | | | | |
| Long Chain Alcohol | Non-ionic | BASF Plurafac LF | 3.00 | 5.00 | 3.00 |
| Alkoxylate | Surfactant | 901 | | | |
| Sodium acetate, anhydrous | Hardening | Sodium acetate, | 5.00 | 5.00 | 5.00 |
| | agent | anhydrous | | | |
| Monoethanolamine, 99% | Alkalinity | Monoethanolamine, | — | — | 2.00 |
| | Source | 99% | | | |

The solid concentrates in Example 2 were made by thoroughly mixing all of the granular and powdered materials until uniform. Then, all of the liquid materials were thoroughly mixed together until uniform. The liquid mixture and the granular/powdered mixture were fed as separate streams into a twin screw extruder, thoroughly mixed until uniform in the extruder, and extruded. The extruded solid was cut into blocks and allowed to harden.

### Example 3

Extruded solid formulations including low caustic concentration components and having the compositions provided in Table 3 below were prepared.

TABLE 3

| | | | % by weight | | |
|---|---|---|---|---|---|
| Chemical | Category | Tradename | Composition X | Composition Y | Composition Z |
| Amine oxide - 60% | Surfactant | Lonza Barlox 1260 | 7.70 | 7.70 | 7.70 |
| actives | | | | | |
| Long Chain Alcohol | Non-ionic | BASF Plurafac LF | 3.30 | 5.50 | 3.30 |
| Alkoxylate | Surfactant | 901 | | | |
| Sodium Metasilicate | Corrosion | Sodium | 3.50 | 3.50 | 3.50 |
| Pentahydrate | Inhibitor | Metasilicate | | | |
| | | Pentahydrate | | | |
| Sodium hydroxide, 96% | Alkalinity | Sodium hydroxide | 15.00 | 15.00 | 15.00 |
| minimum | Source | bead | | | |
| Sodium Gluconate, | Chelator | Sodium Gluconate, | 0.50 | 0.50 | 0.50 |
| powdered | | powdered | | | |
| Sodium Carbonate | Alkalinity | Sodium Carbonate | 38.60 | 38.60 | 38.60 |
| | Source | | | | |
| Sodium Bicarbonate | Corrosion | Sodium | 3.50 | 3.50 | 3.50 |
| | Inhibitor | Bicarbonate | | | |
| Perfume | Perfume | J&E Sozio Orange | 0.50 | 0.50 | 0.50 |
| | | Fragrance SZ- | | | |
| | | 40173 | | | |
| Dye | Dye | Liquitint Brilliant | 0.20 | 0.20 | 0.20 |
| | | Orange | | | |
| Ethylenediaminetetraacetic | Chelator | Akzo Nobel | 20.00 | 20.00 | 20.00 |
| acid tetrasodium salt, 99% | | Dissolvine 220-S | | | |
| minimum | | | | | |
| Amino methyl propanol- | Alkalinity | Unger AMP 95 | 2.20 | — | — |
| 95% | Source | | | | |
| Sodium acetate, anhydrous | Hardening | Sodium acetate, | 5.00 | 5.00 | 5.00 |
| | agent | anhydrous | | | |
| Monoethanolamine, 99% | Alkalinity | Monoethanolamine, | — | — | 2.20 |
| | Source | 99% | | | |

The solid concentrates in Example 3 were made by thoroughly mixing all of the granular and powdered materials until uniform. All of the liquid materials were thoroughly mixed together until uniform. The liquid mixture and the granular/powdered mixture were fed as separate streams into a twin screw extruder, thoroughly mixed until uniform in the extruder, and extruded. The extruded solid was cut into blocks and allowed to harden.

### Example 4

An extruded solid formulation including low caustic concentration components and having the composition provided in Table 4 below could be prepared.

TABLE 4

| | | | % by |
|---|---|---|---|
| Chemical | Tradename | Category | Weight |
| Sodium Carbonate | Sodium | Secondary | 33.6 |
| | Carbonate | Alkalinity Source | |
| Sodium Bicarbonate | Sodium | Corrosion | 3.50 |
| | Bicarbonate | Inhibitor | |
| Sodium Metasilicate | Sodium | Corrosion | 3.50 |
| Pentahydrate | Metasilicate | Inhibitor | |
| | Pentahydrate | | |
| Amine oxide - 60% actives | Lonza Barlox | Surfactant | 7.70 |
| | 1260 | | |
| Sodium xylene sulfonate, | Stepanate | Hydrotrope | 5.00 |
| powdered, 93% active | SXS-93 | | |
| Sodium acetate, anhydrous | Sodium | Hardening agent | 5.00 |
| | acetate, | | |
| | anhydrous | | |
| Fragrance | J&E Sozio | Fragrance | 0.50 |
| | Orange | | |
| | Fragrance SZ- | | |
| | 40173 | | |
| Dye | Liquitint | Dye | 0.20 |
| | Brilliant | | |
| | Orange | | |
| Sodium hydroxide, 96% | Sodium | Alkalinity Source | 15.00 |
| minimum | hydroxide | | |
| | bead | | |
| Ethylenediaminetetraacetic | Akzo Nobel | Chelating agent | 20.00 |
| acid tetrasodium salt, 99% | Dissolvine | | |
| minimum | 220-S | | |
| Alcohol ethoxylate | Air Products | Surfactant | 5.50 |
| | Tomadol 1-5 | | |
| Sodium gluconate | Sodium | Chelating agent | 0.50 |
| powdered | gluconate | | |
| | powdered | | |

The solid concentrate in Example 4 is made by thoroughly mixing all of the granular and powdered materials until uniform. Then, thoroughly mix together all of the liquid materials until uniform. The liquid mixture and the granular/powdered mixture are fed as separate streams into a twin screw extruder, thoroughly mixed until uniform in the extruder, and extruded. The extruded solid is cut into blocks and allowed to harden.

### Example 5

An extruded solid formulation including high caustic concentration components and having the composition provided in Table 5 below could be prepared.

TABLE 5

| | | | % by |
|---|---|---|---|
| Chemical | Tradename | Category | Weight |
| Alcohol Alkoxylate | Plurafac LF | Surfactant | 3.00 |
| | 901 | | |
| Sodium Carbonate | Sodium | Alkalinity | 22.8 |
| | Carbonate | Source | |
| Sodium Metasilicate | Sodium | Corrosion | 3.50 |
| Pentahydrate | Metasilicate | Inhibitor | |
| | Pentahydrate | | |
| Amine oxide - 60% | Lonza | Surfactant | 7.00 |
| actives | Barlox 1260 | | |
| Sodium acetate powdered | Sodium | Hardening | 5.00 |
| | acetate | agent | |
| | powdered | | |
| Fragrance | J&E Sozio | Fragrance | 0.50 |
| | Orange | | |
| | Fragrance | | |
| | SZ-40173 | | |
| Dye | Liquitint | Dye | 0.20 |
| | Brilliant | | |
| | Orange | | |
| Sodium hydroxide, 96% | Sodium | Alkalinity | 30.00 |
| minimum | hydroxide | Source | |
| | bead | | |
| Ethylenediaminetetraacetic | Akzo Nobel | Chelating | 25.00 |
| acid tetrasodium salt, 99% | Dissolvine | agent | |
| minimum | 220-S | | |
| Tripropylene glycol | DOW | Solvent | 2.00 |
| methyl ether | Dowanol | | |
| | TPM | | |
| Sodium gluconate | Sodium | Chelating | 1.0 |
| powdered | gluconate | agent | |
| | powdered | | |

The solid concentrates in Example 5 are made by thoroughly mixing all of the granular and powdered materials until uniform. Then, thoroughly mix together all of the liquid materials until uniform. The liquid mixture and the granular/powdered mixture are fed as separate streams into a twin screw extruder, thoroughly mixed until uniform in the extruder, and extruded. The extruded solid is cut into blocks and allowed to harden.

### Example 6

This Example 6 demonstrates the efficacy of compositions of the invention in removing greasy soils as compared to a commercially available control.

A use solution of Composition Z provided above in Example 3 was prepared by dissolving 14.98 grams of Composition Z solid in 1 liter of water. The use composition was then sprayed through a spray bottle or placed dropwise alongside the control degreaser, Titan™ degreaser available from Ecolab, Inc. located in St. Paul, Minn. at a 1:9 dilution by volume, and left to sit for 1.5 minutes onto a variety of fresh and spent kitchen fats, greases and oils, placed on a hard surface comprised of stainless steel. After the 1.5 minutes had elapsed the soil was gently rinsed with cold water. The panel was allowed to dry. The relative soil removal was compared with the control's cleaning performance on the same panel.

Composition Z use solution was effective at degreasing/cleaning 100% of spent animal fats from the stainless steel hard surface, whereas the control was effective at degreasing/cleaning 50% of spent animal fats from the stainless steel hard surface.

The present invention is not limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

We claim:

1. A concentrate composition, comprising:
(a) an amine oxide surfactant,
(b) an alkali metal hydroxide
(c) a secondary source of alkalinity,
(d) a surfactant, and
(e) a chelating agent,
wherein the composition is formed into a solid useful in preparing a stable, aqueous use solution.

2. The composition of claim 1 further comprising any one or combination of a corrosion inhibitor, solvent, hydrotrope, dye, or perfume.

3. The composition of claim 2 wherein the corrosion inhibitor is comprised of sodium metasilicate, potassium silicate, sodium silicate, sodium bicarbonate or a combination thereof.

4. The composition of claim 2 wherein the solvent is comprised of glycol ether.

5. The composition of claim 2 wherein the hydrotrope is comprised of sodium xylene sulfonate.

6. The composition of claim 1 further comprising a hardening agent.

7. The composition of claim 1 wherein the surfactant is comprised of a nonionic surfactant.

8. The composition of claim 1 wherein the surfactant is comprised of an anionic surfactant.

9. The composition of claim 1 wherein the surfactant is comprised of a combination of nonionic and anionic surfactants.

10. The composition of claim 6 wherein the hardening agent is comprised of polyethylene glycol, sodium acetate, sodium sulfate, sodium carbonate, sodium tripoly phosphate, or a combination thereof.

11. The composition of claim 6 wherein the hardening agent is comprised of urea, water and non-ionic surfactant.

12. The composition of claim 1 wherein the secondary source of alkalinity is comprised of alkanolamines, amino alcohols, alkali metal salts, silicates and phosphates, or a combination thereof.

13. The composition of claim 1 wherein the amine oxide surfactant is comprised of lauryl dimethyl amine oxide.

14. The composition of claim 7 wherein the nonionic surfactant is comprised of at least one long chain alkoxylated alcohol.

15. The composition of claim 1 wherein the source of alkali metal hydroxide is comprised of sodium hydroxide, potassium hydroxide or a combination thereof.

16. The composition of claim 1 wherein the chelating agent is comprised of dicarboxymethyl glutamic acid tetrasodium salt, methylglycine-N—N-diacetic acid trisodium salt, iminodisuccinate sodium salt, ethylenediaminetetraacetic acid tetrasodium salt, sodium gluconate, or a combination thereof.

17. The composition of claim 1 wherein the solid is made from casting or extruding.

18. The composition of claim 1 wherein the solid is a tablet, a pressed solid, or a powdered solid.

19. The composition of claim 1 wherein the solid concentrated is substantially nonaqueous.

20. A substantially nonaqueous concentrate composition, comprising:
(a) 1-10 wt % amine oxide,
(b) 5-50 wt % alkali metal hydroxide,
(c) 0.5-55 wt % secondary alkalinity source,
(d) 0.05-70 wt % surfactant,
(e) 0.5-60 wt % chelating agent, and
wherein the concentrate composition is formed into a solid and the solid concentrate is useful in preparing a stable, aqueous use solution.

21. The composition of claim 20 wherein the surfactant is comprised of a nonionic surfactant.

22. The composition of claim 20 wherein the nonionic surfactant is an alcohol alkoxylate.

23. The composition of claim 20 further comprising a hardening agent.

24. A substantially nonaqueous concentrate composition, comprising:
(a) 5-10 wt % amine oxide,
(b) 5-35 wt % alkali metal hydroxide,
(c) 20-45 wt % secondary alkalinity source,
(d) 0.05-8 wt % surfactant,
(e) 15-30 wt % chelating agent, and
wherein the concentrate composition is formed into a solid and the solid concentrate is useful in preparing a stable, aqueous use solution.

25. The composition of claim 24 further comprising 1-20 wt % hardening agent.

26. The composition of claim 25 wherein the hardening agent is comprised of sodium acetate, polyethylene glycol, or a combination thereof.

27. The composition of claim 24 further comprising a corrosion inhibitor.

28. The composition of claim 24 wherein the corrosion inhibitor is comprised of sodium metasilicate.

29. The composition of claim 23 wherein the solid concentrate is substantially nonaqueous.
